(19) United States
(12) Patent Application Publication
(10) Pub. No.: US 2023/0080775 A1
(43) Pub. Date: Mar. 16, 2023

(54) POLYISOCYANATE PREPARATIONS

(71) Applicant: Covestro Deutschland AG, Leverkusen (DE)

(72) Inventors: Hans-Josef Laas, Odenthal (DE); Eva Tejada Rosales, Mollet del Valles (ES)

(21) Appl. No.: 17/796,734

(22) PCT Filed: Feb. 11, 2021
(86) PCT No.: PCT/EP2021/053264

§ 371 Date: Aug. 1, 2022

(30) Foreign Application Priority Data
Feb. 17, 2020 (EP) 20157573.5
Sep. 18, 2020 (EP) 20197008.4

(51) Int. Cl. C08G 18/08; C08G 18/79; C08G 18/76; C08G 18/73; C08G 18/02; C09D 175/04

(52) U.S. Cl. CPC C08G 18/0828; C08G 18/794; C08G 18/792; C08G 18/7621; C08G 18/73; C08G 18/022; C09D 175/04

(57) ABSTRACT

The invention relates to a polyisocyanate preparation containing at least one polyisocyanate component A) hydrophilically modified with at least one ionic emulsifier and a solvent component E) consisting of at least one organic solvent, characterized in that the solvent component E) has a content of peroxides of not more than 70 mg/l of H₂O₂ equivalents, wherein this value is the average peroxide content of all organic solvents present in the solvent component E) and the polyisocyanate component A) and the solvent component E) are present in amounts such that the calculated peroxide content of the polyisocyanate preparation based on the sum of A) and E) is not more than 20 mg/l of H₂O₂. The invention further relates to the use thereof and to coating compositions and substrates coated with these coating compositions.

The invention relates to solvent-containing polyisocyanate preparations and to the use of said preparations for producing polyurethane plastics. The invention additionally relates to coating compositions comprising the polyisocyanate preparations and also to the substrates coated with said coating compositions.

Aqueous coating systems are nowadays firmly established for various fields of application as an eco-friendly alternative to solvent-containing coating compositions. Hydrophilically modified polyisocyanates play a particular role as raw material for high-quality aqueous coatings since, as water-dispersible crosslinker components, they enable the formulation of aqueous two-component polyurethane coatings (2K-PUR coatings) which are comparable and in some cases even superior to solvent-based coatings in terms of mechanical and chemical resistance.

In principle, the hydrophilically modified polyisocyanate crosslinkers may be used in solvent-free form. However, they are usually diluted with organic solvents before application to reduce viscosity and facilitate stirring into the aqueous binder component. These are mostly the customary paint solvents which are chemically inert to isocyanate groups, as are described, for example, in EP-A 0 540 985 or WO 2001/88006. In addition, however, acetals (WO 2007/110425), dioxolane (WO 2017/042111) or even special fluorinated solvents (WO 2008/042325) have been proposed as co-solvents for hydrophilically modified polyisocyanates, which are said to result in particularly finely divided dispersions and thus in an increased gloss of the coatings obtained.

In the production of crosslinker solutions from hydrophilic polyisocyanates comprising ionic emulsifiers, it is often observed in practice that using different batches of one and the same solvent, solutions are obtained which differ noticeably in terms of their inherent color, an effect which is undesirable in the sense of constant product quality. Depending on the quality of the solvents used, organic solutions of ionically hydrophilized polyisocyanates may even reach such high color indices after a short storage time that their usability as crosslinkers for high-quality coating systems is considerably restricted or excluded.

The object of the present invention was therefore to provide novel crosslinker solutions based on polyisocyanates comprising ionic emulsifiers which can be prepared reproducibly having low color indices and which behave in a largely color-stable manner even after prolonged storage, for example even at elevated temperature.

This object was achieved by providing the polyisocyanate preparations according to the invention that are described in more detail below, and the process for preparation thereof. The polyisocyanate preparations according to the invention described in more detail below are based on the surprising observation that the color of organic solutions of ionically hydrophilized polyisocyanates correlates to a high degree with the peroxide content of the solvents used. Whereas polyisocyanate solutions prepared using solvents having peroxide contents of more than 70 mg/l H₂O₂ equivalents discolor markedly after only a short period of storage, in some cases even at room temperature, the use of solvents having peroxide contents of not more than 70, preferably not more than 60 and particularly preferably not more than 50 mg/l H₂O₂ equivalents, gives rise to reproducibly color-stable solutions.

This was surprising, as it is known to those skilled in the art that the color indices of polyisocyanates can be significantly reduced by oxidation, for example by adding peroxides (EP-A 0 377 177) or peroxycarboxylic acids (EP-A 0 630 928) or by treatment with elemental oxygen (EP-A 0 569 804).

The present invention relates to polyisocyanate preparations comprising at least one polyisocyanate component A) hydrophilically modified with at least one ionic emulsifier and a solvent component E) consisting of at least one organic solvent, characterized in that the solvent component E) has a peroxide content of at most 70 mg/l H₂O₂ equivalents, preferably of at most 60 mg/l H₂O₂ equivalents, particularly preferably of at most 50 mg/l H₂O₂ equivalents, wherein this value is the average peroxide content of all organic solvents present in the solvent component E), and the polyisocyanate component A) and the solvent component E) are present in amounts such that the calculated peroxide content of the polyisocyanate preparation is at most 20 mg/l H₂O₂ equivalents, based on the sum of A) and E).

The invention also relates to the use of these polyisocyanate preparations in the production of polyurethane plastics, particularly as crosslinkers for water-soluble or dispersible paint binders or paint binder components having groups that are reactive to isocyanate groups.

According to the invention, the terms “comprising” or “containing” preferably mean “consisting essentially of” and particularly preferably mean “consisting of”.

In the present case, the term “H₂O₂ equivalents” (hereinafter also abbreviated to “H₂O₂”) is understood to mean a collective term for a wide variety of compounds, all of which have at least one peroxide group. Thus, in addition to hydrogen peroxide itself, the term “H₂O₂ equivalent” also includes any compounds having at least one peroxide group, for example organic peroxides and hydroperoxides. In the context of the present invention, the term “peroxide content” is used as a synonym for the term “H₂O₂ equivalents”.

The hydrophilically modified polyisocyanate components A) present in the polyisocyanate preparations according to the invention consist of a polyisocyanate component B) and at least one ionic emulsifier C).

Suitable polyisocyanate components B) are for example any diisocyanates and/or triisocyanates having aliphatically, cycloaliphatically, araliphatically and/or aromatically bonded isocyanate groups, which are accessible in various ways, for example by phosgenation of corresponding diamines or triamines in the liquid or gas phase or by a phosgene-free route, such as thermal urethane cleavage for example.

For example, simple monomeric diisocyanates and triisocyanates having aliphatically and/or cycloaliphatically bonded isocyanate groups are suitable, preferably those in the 140 to 400 molecular weight range, for example 1,4-diisocyanatobutane, 1,5-diisocyanatopentane (pentamethylene diisocyanate, PDI), 1,6-diisocyanatohexane (hexamethylene diisocyanate, HDI), 2-methyl-1,5-diisocyanatopentane, 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophoronediisocyanate, IPDI), 2,4′- and 4,4′-diisocyanatodicyclohexylmethane, 1-isocyanato-1-methyl-4(3)isocyanatomethylcyclohexane, bis(isocyanatomethyl)norbornane, 1,8-diisocyanato-4-(isocyanatomethyl)octane (triisocyanatononane, TIN), 2-isocyanatoethyl 2,6-diisocyanatohexanoate (lysine ester triisocyanate, LTI) or monomeric diisocyanates and triisocyanates having araliphatically and/or aromatically bonded isocyanate groups, preferably those in the 160 to 600 molecular weight range, for example 1,3- and 1,4-bis(isocyanatomethyl)benzene (xylylene diisocyanate, XDI), 1,3- and 1,4-bis(2-isocyanatopropan-2-yl)benzene (tetramethylxylylene diisocyanate, TMXDI), 1,3-bis(isocyanatomethyl)-4-methylbenzene, 1,3-bis(isocyanatomethyl)-4-ethylbenzene, 1,3-bis(isocyanatomethyl)-5-methylbenzene, 1,3-bis(isocyanatomethyl)-4,5-dimethylbenzene, 1,4-bis(isocyanatomethyl)-2,5-dimethylbenzene, 1,4-bis(isocyanatomethyl)-2,3,5,6-tetramethylbenzene, 1,3-bis(isocyanatomethyl)-5-tert-butylbenzene, 1,3-bis(isocyanatomethyl)-4-chlorobenzene, 1,3-bis(isocyanatomethyl)-4,5-dichlorobenzene, 1,3-bis(isocyanatomethyl)-2,4,5,6-tetrachlorobenzene, 1,4-bis(isocyanatomethyl)-2,3,5,6-tetrachlorobenzene, 1,4-bis(isocyanatomethyl)-2,3,5,6-tetrabromobenzene, 1,4-bis(2-isocyanatoethyl)benzene and 1,4-bis(isocyanatomethyl)naphthalene, 1,2-, 1,3- and 1,4-diisocyanatobenzene (phenylene diisocyanate), 2,4- and 2,6-diisocyanatotoluene (tolylene diisocyanate, TDI), 2,3,5,6-tetramethyl-1,4-diisocyanatobenzene, the isomeric diethylphenylene diisocyanates, diisopropylphenylene diisocyanates, diisododecylphenylene diisocyanates and biphenyl diisocyanates, 3,3′-dimethoxybiphenyl 4,4′-diisocyanate, 2,2′-, 2,4′- and 4,4′-diisocyanatodiphenylmethane (MDI), 3,3′-dimethyldiphenylmethane 4,4′-diisocyanate, 4,4′-diisocyanatodiphenylethane, 1,5-diisocyanatonaphthalene (NDI), diphenyl ether diisocyanate, ethylene glycol diphenyl ether diisocyanate, diethylene glycol diphenyl ether diisocyanate, 1,3-propylene glycol diphenyl ether diisocyanate, benzophenone diisocyanate, triisocyanatobenzene, 2,4,6-triisocyanatotoluene, trimethylbenzene triisocyanate, diphenylmethane 2,4,4′-triisocyanate, 3-methyldiphenylmethane 4,6,4′-triisocyanate, the isomeric naphthalene triisocyanates and methylnaphthalene diisocyanates, triphenylmethane triisocyanate, 2,4-diisocyanato-1-[(5-isocyanato-2-methylphenypmethyl]benzene or mixtures of at least two such diisocyanates and triisocyanates.

Likewise suitable polyisocyanate components B) are also the polynuclear homologs of diisocyanatodiphenylmethane known as “polymer-MDI”.

Particularly suitable polyisocyanate components B) are polyisocyanates obtainable by modifying the aforementioned monomeric diisocyanates and/or triisocyanates, for example polyisocyanates prepared from aliphatic and/or cycloaliphatic diisocyanates and having a uretdione, isocyanurate, allophanate, biuret, iminooxadiazinedione and/or oxadiazine trione structure, as described for example in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or are described by way of example in EP-A 0 336 205, EP-A 0 339 396 and EP-A 0 798 299, or polyisocyanates having urethane and/or isocyanurate structure prepared from monomeric 2,4- and/or 2,6-TDI by reaction with polyols and/or oligomerization, preferably trimerization, as are described, for example, in DE-A 870 400, DE-A 953 012, DE-A 1 090 196, EP-A 0 546 399, CN 105218780, CN 103881050, CN 101717571, US 3 183 112, EP-A 0 416 338, EP-A 0 751 163, EP-A 1 378 529, EP-A 1 378 530, EP -A 2 174 967, JP 63260915 or JP 56059828, or mixtures of at least two such polyisocyanates.

Particularly suitable polyisocyanate components B) are also those bearing both aromatic and aliphatic isocyanate groups, for example the mixed trimers or allophonates of 2,4- and/or 2,6-TDI with HDI described in DE-A 1 670 667, EP-A 0 078 991, EP-A 0 696 606 and EP-A 0 807 623.

In the production of these polyisocyanate components B) from diisocyanates and/or triisocyanates, the actual modification reaction is generally followed by a further process step for removing the unreacted excess monomeric diisocyanates and/or triisocyanates. This removal of monomers is effected by processes known per se, preferably by thin-film distillation under high vacuum or by extraction with suitable solvents inert to isocyanate groups, for example aliphatic or cycloaliphatic hydrocarbons such as pentane, hexane, heptane, cyclopentane or cyclohexane.

The polyisocyanate component B) preferably has a content of monomeric diisocyanates of less than 1.5% by weight, preferably less than 1.0% by weight, particularly preferably less than 0.5% by weight, based on the solids content of the polyisocyanate. The residual monomer contents are measured according to DIN EN ISO 10283:2007-11 by gas chromatography with an internal standard.

Particular preference is given to polyisocyanate components B) produced by modifying PDI, HDI, IPDI, 4,4′-diisocyanatodicyclohexylmethane, XDI, 2,4- and/or 2,6-TDI.

Very particularly preferred polyisocyanate components B) are isocyanurate group-containing polyisocyanates based on PDI, HDI and/or IPDI and urethane group-containing TDI polyisocyanates, in particular low-monomer reaction products of 2,4- and/or 2,6-TDI with 1,1,1-trimethylolpropane (TMP) and optionally other preferably low molecular weight alcohols in the molecular weight range from 62 to 194 g/mol, such as diethylene glycol for example.

The polyisocyanate components B) mentioned above as suitable, particularly suitable, preferred, particularly preferred and especially preferred, preferably have an average NCO functionality of 2.3 to 5.0, preferably of 2.5 to 4.5, and a content of isocyanate groups of 6.0 to 26.0% by weight, preferably of 8.0 to 25.0% by weight, particularly preferably 10.0 to 24.0% by weight, based on the solids content of the polyisocyanate component.

The hydrophilically modified polyisocyanate components A) present in the polyisocyanate preparations according to the invention comprise at least one ionic emulsifier C) in addition to the polyisocyanate component B).

These are any surface-active substances comprising ionic groups which, due to their molecular structure, are capable of stabilizing polyisocyanates or polyisocyanate compositions in aqueous emulsions over a relatively long period of time, preferably up to 8 hours.

A preferred type of ionic emulsifiers C) are, for example, reaction products C1) of the polyisocyanate components B) with organic compounds bearing at least one isocyanate-reactive group and at least one sulfonic acid or sulfonate group. These are hydroxy-, mercapto- or amino-functional sulfonic acids and/or salts thereof known per se or are mixtures of at least two such compounds.

Examples of suitable formation components for the preparation of emulsifiers C1) are hydroxysulfonic acids of the general formula (I)

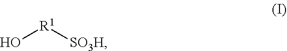

in which R′ is an alkyl or aryl radical having up to 10 carbon atoms, which may comprise ester groups, carbonyl groups, up to two tertiary amino groups and/or hydroxyl groups, or is a five- or six-membered cycloaliphatic radical, which may optionally comprise nitrogen or oxygen atoms and may also be substituted by further hydroxyl groups.

Examples of suitable hydroxysulfonic acids include: 2-hydroxyethanesulfonic acid, 3-hydroxypropanesulfonic acid, 4-hydroxybutanesulfonic acid, 5-hydroxypentanesulfonic acid, 6-hydroxyhexanesulfonic acid, isomeric phenolsulfonic acids, especially 4-hydroxybenzenesulfonic acid, 2-(hydroxymethyl)benzenesulfonic acid, 3,5-bis(hydroxymethyl)benzenesulfonic acid, 4-(2-hydroxyethyl)-1-piperazineethanesulfonic acid (HEPES), 4-(2-hydroxyethyl) piperazinepropanesulfonic acid (HEPPS) and 2-hydroxy-4-morpholinepropanesulfonic acid (MOPSO).

Suitable hydroxysulfonic acids are also specific polyethersulfonic acids, such as are described as detergents, for example, in EP-A 0 592 073, U.S. Pat. Nos. 3,102,893 and 2,989,547.

Preferred hydroxysulfonic acids for reaction with the polyisocyanate component A) comprising sulfonate groups are those of the general formula (I), in which R¹ is an alkyl group having up to 6 carbon atoms or an aryl group having 6 to 10 carbon atoms.

Particularly preferred hydroxysulfonic acids are 2-hydroxyethanesulfonic acid, 3-hydroxypropanesulfonic acid, 4-hydroxybenzenesulfonic acid and/or 2-(hydroxymethyl)benzenesulfonic acid.

Mercaptosulfonic acids, such as 2-mercaptoethanesulfonic acid and 3-mercaptopropane-1-sulfonic acid, are also suitable for preparing the ionic emulsifiers C1).

Suitable amino-functional sulfonic acids for preparing emulsifiers C1) are, for example, substituted aromatic sulfonic acids, which may bear up to three sulfonic acid groups and comprise up to three, preferably up to two, particularly preferably precisely one primary or secondary, preferably precisely one primary amino group, wherein the positions on the aromatic ring in the position ortho to the amino group are unsubstituted.

These are preferably substituted aromatic sulfonic acids of the general formula (II)

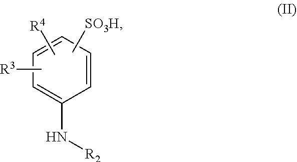

in which R², R³ and R⁴ are each independently identical or different radicals and denote hydrogen or saturated or unsaturated, linear or branched, aliphatic, cycloaliphatic, araliphatic or aromatic organic radicals, which may additionally comprise heteroatoms in the chain, wherein R³ and R⁴ may together also form a ring, preferably a fused aromatic ring, in combination with each other, with the proviso that at least one of the radicals R³ and R⁴ is not hydrogen.

Aliphatic or araliphatic radicals R², R³ and R⁴ in formula (II) are preferably those having 1 to 18 carbon atoms such as, for example, a methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hexadecyl, octadecyl, 1,1-dimethylpropyl, 1,1-dimethylbutyl, 1,1,3,3-tetramethylbutyl, benzyl, 1-phenylethyl, 2-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, butylthiomethyl, 2-dodecylthioethyl, 2-phenylthioethyl, 2,2,2-trifluoroethyl, 2-phenoxyethyl, 2-phenoxypropyl, 3-phenoxypropyl, 4-phenoxybutyl, 6-phenoxyhexyl, 2-methoxy ethyl, 2-methoxypropyl, 3-methoxypropyl, 4-methoxybutyl, 6-methoxyhexyl, 2-ethoxypropyl, 3-ethoxypropyl, 4-ethoxybutyl or 6-ethoxyhexyl radical.

Cycloaliphatic radicals R², R³ and R⁴ in formula (II) are preferably those having 5 to 12 carbon atoms such as, for example, a cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl radical and also saturated or unsaturated bicyclic systems such as, for example, a norbornyl or a norbornenyl radical.

Aromatic radicals R², R³ and R⁴ in formula (II) are preferably those having 6 to 12 carbon atoms such as, for example, a phenyl, tolyl, xylyl, o-naphthyl, ß-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl radical.

If the radicals R³ and R⁴ in formula (II) together form a ring, R³ and R⁴ are preferably a but-1,4-ylene chain or particularly preferably a 1,3-butadien-1,4-ylene chain, which means that the aromatic sulfonic acids in this case preferably have a tetrahydronaphthalene or particularly preferably a naphthalene structure.

The radical R² is particularly preferably hydrogen, a methyl, ethyl, n-propyl, isopropyl, tert-butyl, cyclopentyl or cyclohexyl radical, especially preferably hydrogen.

The radicals R³ and R⁴ are particularly preferably each independently hydrogen, a methyl, ethyl, isopropyl, tert-butyl, hexyl, octyl, nonyl, decyl, dodecyl, phenyl or naphthyl radical, especially preferably hydrogen and/or a methyl group. In this case, preferably one of the radicals R4 and R5 is hydrogen while the other is other than hydrogen.

The sulfonic acid group in formula (II), as well as the substituents R³ and R⁴, is in the para- or meta-position on the aromatic ring based on the primary or secondary amino group, the sulfonic acid group preferably in this case being in the meta-position.

Examples of suitable aromatic aminosulfonic acids of the general formula (II) for preparing emulsifiers C1) are 4-aminotoluene-2-sulfonic acid, 5-aminotoluene-2-sulfonic acid or 2-aminonaphthalene-4-sulfonic acid, particular preference being given to 4-aminotoluene-2-sulfonic acid.

Finally, other amino-functional sulfonic acids for reaction with the polyisocyanate components B) to form emulsifiers C1) are also those of the general formula (III)

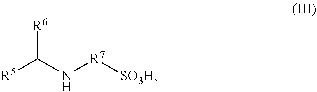

in which R⁵ and R⁶ are each independently identical or different radicals and are hydrogen or saturated or unsaturated, linear or branched, aliphatic or cycloaliphatic or aromatic organic radicals having 1 to 18 carbon atoms, which are substituted or unsubstituted and/or comprise heteroatoms in the chain, wherein R⁵ and R⁶, in combination with each other and optionally one further nitrogen atom or one oxygen atom, may also form cycloaliphatic or heterocyclic rings having 3 to 8 carbon atoms, which may optionally be further substituted, and IC is a linear or branched aliphatic radical having 2 to 6 carbon atoms.

In the general formula (III), R⁵ and R⁶ are each independently preferably saturated, linear or branched, aliphatic or cycloaliphatic organic radicals having 1 to 8 carbon atoms, which may also form cycloaliphatic rings in combination with each other, and IC is a linear or branched aliphatic radical having 2 to 4 carbon atoms.

Suitable aminosulfonic acids of the general formula (III) are, for example, 2-aminoethanesulfonic acid, 3-aminopropane-1-sulfonic acid, 4-aminobutane-1-sulfonic acid, 3-aminobutane-1-sulfonic acid, 3-amino-2-methylpropane-1-sulfonic acid, 4-aminobutane-2-sulfonic acid, 2-methylaminoethane-1-sulfonic acid, 2-ethylaminoethane-1-sulfonic acid, 2-propylaminoethane-1-sulfonic acid, 2-isopropylaminoethane-1-sulfonic acid, 2-n-butylaminoethane-1-sulfonic acid, 2-(tert-butyl)aminoethane-1-sulfonic acid, 2-pentylaminoethane-1-sulfonic acid, 2-hexylaminoethane-1-sulfonic acid, 2-octylaminoethane-1-sulfonic acid, 2-anilinoethane-1-sulfonic acid, 2-cyclopropylaminoethane-1- sulfonic acid, 2-cyclobutylaminoethane-1-sulfonic acid, 2-cyclopentylaminoethane-1-sulfonic acid, 2-cyclohexylaminoethane-1-sulfonic acid, the isomeric 2-(methylcyclohexyl) aminoethane-1-sulfonic acids, 2-(2,3-dimethylcyclohexyl)aminoethane sulfonic acid, 2-(3,3,5-trimethylcyclohexyl)aminoethane-1-sulfonic acid, 2-(4-tert-butylcyclohexyl)aminoethane-1-sulfonic acid, 2-cycloheptylaminoethane-1-sulfonic acid, 2-cyclooctylaminoethane-1-sulfonic acid, 2-(2-norbornyl)aminoethane-1-sulfonic acid, 2-(1-adamantyl)aminoethane-1-sulfonic acid, 2-(3,5-dimethyl-1-adamantyl)aminoethane-1-sulfonic acid, 3-methylaminopropane-1-sulfonic acid, 3-ethylaminopropane-1-sulfonic acid, 3-propylaminopropane-1-sulfonic acid, 3-isopropylaminopropane-1-sulfonic acid, 3-n-butylaminopropane-1-sulfonic acid, 3-(tert-butyl)aminopropane-1-sulfonic acid, 3-pentylaminopropane-1-sulfonic acid, 3-hexylaminopropane-1-sulfonic acid, 3-octylaminopropane-1-sulfonic acid, 3-anilinopropane-1-sulfonic acid, 3-cyclopropylaminopropane-1-sulfonic acid, 3-cyclobutylaminopropane-1-sulfonic acid, 3-cy clopenty laminopropane-1-sulfonic acid, 3-cyclohexylaminopropane-1-sulfonic acid, the isomeric 3-(methylcyclohexyl)aminopropane-1-sulfonic acids, 3-(2,3-dimethylcyclohexyl) aminopropane-1-sulfonic acid, 3-(3,3,5-trimethylcyclohexylaminopropane-1-sulfonic acid, 3-(4-tert-butylcy clohexyl) aminopropane-1-sulfonic acid, 3-cycloheptylaminopropane-1-sulfonic acid, 3-cyclooctylaminopropane-1-sulfonic acid, 3-(2-norbornyl) aminopropane-1-sulfonic acid, 3-(1-adamantyl)aminopropane-1-sulfonic acid, 3-(3,5-dimethyl-1-adamantypaminopropane-1-sulfonic acid, 3-methylaminobutane-1-sulfonic acid, 3-ethylaminobutane-1-sulfonic acid, 3-propylaminobutane-1-sulfonic acid, 3-isopropylaminobutane -1-sulfonic acid, 3-n-butylaminobutane-1-sulfonic acid, 3-(tert-butypaminobutane-1-sulfonic acid, 3-pentylaminobutane-1-sulfonic acid, 3-hexylaminobutane-1-sulfonic acid, 3-octylaminobutane-1-sulfonic acid, 3-anilinobutane-1-sulfonic acid, 3-cyclopropylaminobutane-1-sulfonic acid, 3-cyclobutylaminobutane-1-sulfonic acid, 3-cyclopentylaminobutane-1-sulfonic acid, 3-cyclohexylaminobutane-1-sulfonic acid, the isomeric 3-(methylcyclohexyl) aminobutane-1-sulfonic acids, 3-(2,3-dimethylcyclohexyl)aminobutane-1-sulfonic acid, 3-(3,3,5-trimethylcyclohexylaminobutane-1-sulfonic acid, 3-(4-tert-butylcyclohexyl)aminobutane-1-sulfonic acid, 3-cycloheptylaminobutane-1-sulfonic acid, 3-cyclooctylaminobutane-1-sulfonic acid, 3-(2-norbornyl) aminobutane-1-sulfonic acid, 3-(1-adamantyl) aminobutane-1-sulfonic acid, 3-(3, 5-dimethyl-1-adamantyl)aminobutane-1-sulfonic acid, 4-methylaminobutane-1-sulfonic acid, 4-ethylaminobutane-1-sulfonic acid, 4-propylaminobutane-1-sulfonic acid, 4-isopropylaminobutane-1-sulfonic acid, 4-n-butylaminobutane-1-sulfonic acid, 4-(tert-butyl)aminobutane-1-sulfonic acid, 4-pentylaminobutane-1-sulfonic acid, 4-hexylaminobutane-1-sulfonic acid, 4-octylaminobutane-1-sulfonic acid, 4-anilinobutane-1-sulfonic acid, 4-cyclopropylaminobutane-1-sulfonic acid, 4-cyclobutylaminobutane-1-sulfonic acid, 4-cyclopentylaminobutane-1-sulfonic acid, 4-cyclohexylaminobutane-1-sulfonic acid, the isomeric 4-(methylcyclohexyl)aminobutane-1-sulfonic acids, 4-(2,3-dimethylcyclohexyl) aminobutane-1-sulfonic acid, 4-(3,3,5-trimethylcyclohexylaminobutane-1-sulfonic acid, 4-(4-tert-butylcyclohexypaminobutane-1-sulfonic acid, 4-cycloheptylaminobutane-1-sulfonic acid, 4-cyclooctylaminobutane-1-sulfonic acid, 4-(2-norbornyl)aminobutane-1-sulfonic acid, 4-(1-adamantyl)aminobutane-1-sulfonic acid, 4-(3,5-dimethyl-1-adamantyl) aminobutane-1-sulfonic acid, 3-methylamino-2-methylpropane-1-sulfonic acid, 3-ethylamino-2-methylpropane-1-sulfonic acid, 3-propylamino-2-methylpropane-1-sulfonic acid, 3-isopropylamino-2-methylpropane-1-sulfonic acid, 3-n-butylamino-2-methylpropane sulfonic acid, 3-(tert-butyl)amino-2-methylpropane-1-sulfonic acid, 3-pentylamino methylpropane-1-sulfonic acid, 3-hexylamino-2-methylpropane-1-sulfonic acid, 3-octylamino methylpropane-1-sulfonic acid, 3-anilino-2-methylpropane-1-sulfonic acid, 3-cyclopropylamino methylpropane-1-sulfonic acid, 3-cyclobutylamino-2-methylpropane-1-sulfonic acid, 3-cyclopentylamino-2-methylpropane-1-sulfonic acid, 3-cyclohexylamino-2-methylpropane sulfonic acid, the isomeric 3-(methylcyclohexyl)amino-2-methylpropane-1-sulfonic acids, 3-(2,3-dimethylcyclohexyl)amino-2-methylpropane-1-sulfonic acid, 3-(3,3,5-trimethylcyclohexylamino-2-methylpropane-1-sulfonic acid, 3-(4-tert-butylcyclohexyl)amino-2-methylpropane-1-sulfonic acid, 3-cycloheptylamino-2-methylpropane-1-sulfonic acid, 3-cyclooctylamino-2-methylpropane-1-sulfonic acid, 3-(2-norbornypamino-2-methylpropane-1-sulfonic acid, 3-(1-adamantyl)amino-2-methylpropane-1-sulfonic acid, 3-(3,5-dimethyl-1-adamantyl)amino -2-methylpropane-1-sulfonic acid, 3-methylaminobutane-2-sulfonic acid, 3-ethylaminobutane-2-sulfonic acid, 3-propylaminobutane-2-sulfonic acid, 3-isopropylaminobutane-2-sulfonic acid, 3-n-butylaminobutane-2-sulfonic acid, 3-(tert-butyl)aminobutane-2-sulfonic acid, 3-pentylaminobutane-2-sulfonic acid, 3-hexylaminobutane-2-sulfonic acid, 3-octylaminobutane-2-sulfonic acid, 3-anilinobutane-2-sulfonic acid, 3-cyclopropylaminobutane-2-sulfonic acid, 3-cyclobutylaminobutane-2-sulfonic acid, 3-cyclopentylaminobutane-2-sulfonic acid, 3-cyclohexylaminobutane-2-sulfonic acid, the isomeric 3-(methylcyclohexyl)aminobutane-2-sulfonic acids, 3-(2,3-dimethylcy clohexyl) aminobutane-2-sulfonic acid, 3-(3,3,5-trimethylcyclohexylaminobutane-2-sulfonic acid, 3-(4-tert-butylcyclohexypaminobutane-2-sulfonic acid, 3-cycloheptylaminobutane-2-sulfonic acid, 3-cyclooctylaminobutane-2-sulfonic acid, 3-(2-norbornyl)aminobutane-2-sulfonic acid, 3-(1-adamantyl)amino-2-sulfonic acid and 3-(3,5-dimethyl-1-adamantyl)aminobutane-2-sulfonic acid.

Particularly preferred aminosulfonic acids for reaction with the polyisocyanate components B) to give emulsifiers Cl) are those of the general formula (III), in which neither of the radicals R⁵ and R⁶ are hydrogen.

Very particularly preferred aminosulfonic acids for reaction with the polyisocyanate components B) are 2-isopropylaminoethane-1-sulfonic acid, 3-isopropylaminopropane-1-sulfonic acid, 4-isopropylaminobutane-1-sulfonic acid, 2-cyclohexylaminoethane-1-sulfonic acid, 3-cyclohexylaminopropane-1-sulfonic acid and 4-cyclohexylaminobutane-1-sulfonic acid.

To prepare emulsifier molecules C1) comprising sulfonate groups, the sulfonic acids bearing at least one group that is reactive to isocyanate groups are at least partially neutralized before, during or after the reaction with the polyisocyanate component B) and in this manner are converted to sulfonate groups.

Suitable neutralizing agents in this case are any bases, such as alkali metal hydroxides or alkaline earth metal hydroxides, but preferably amines, especially tertiary monoamines such as, for example, trimethylamine, triethylamine, the isomeric tripropyl- and tributylamines, N,N-dimethylethylamine, N,N-dimethylpropylamine, N,N-dimethylisopropylamine, N,N-dimethylbutylamine, N,N-dimethylisobutylamine, N,N-dimethyloctylamine, N,N-dimethyl-2-ethylhexylamine, N,N-dimethyllaurylamine, N,N-diethylmethylamine, N,N-diethylpropylamine, N,N-diethylbutylamine, N,N-diethylhexylamine, N,N-diethyloctylamine, N,N-diethyl-2-ethylhexylamine, N,N-diethyllaurylamine, N,N-diisopropylmethylamine, N,N-diisopropylethylamine, N,N-diisopropylbutylamine, N,N-diisopropyl-2-ethylhexylamine, N,N-dioctylmethylamine, N,N-dimethylallylamine, N,N-dimethylbenzylamine, N,N-diethylbenzylamine, N,N-dibenzylmethylamine, tribenzylamine, N,N-dimethyl-4-methylbenzylamine, N,N-dimethylcyclohexylamine, N,N-diethylcyclohexylamine, N,N-dicyclohexylmethylamine, N,N-dicyclohexylethylamine, tricyclohexylamine, N-methylpyrrolidine, N-ethylpyrrolidine, N -propylpyrrolidine, N-butylpyrrolidine, N-methylpiperidine, N-ethylpiperidine, N-propylpiperidine, N-butylpiperidine, N-methylmorpholine, N-ethylmorpholine, N-propylmorpholine, N-butylmorpholine, N-sec-butylmorpholine, N-tert-butylmorpholine, N-isobutylmorpholine and quinuclidine or tertiary diamines such as, for example, 1,3-bis(dimethylamino)propane, 1,4-bis(dimethylamino)butane and N,N′-dimethylpiperazine, or mixtures of at least two such tertiary amines.

Suitable but less preferred neutralizing amines are also additionally tertiary amines bearing groups that are reactive to isocyanates, for example alkanolamines such as dimethylethanolamine, methyldiethanolamine or triethanolamine.

Preferred neutralizing amines for the sulfonic acids are N,N-dimethylbutylamine, N,N-dimethyl-2-ethylhexylamine, N,N-diethylmethylamine, N,N-diisopropylethylamine, N,N-diisopropyl-2-ethylhexylamine, N,N-dimethylcyclohexylamine, N,N-dicyclohexylmethylamine, N-methylpyrrolidine, N-methylpiperidine, N-ethylpiperidine, N-methylmorpholine, N-ethylmorpholine, N-isobutylmorpholine or mixtures thereof.

Particular preference is given to N,N-dimethylbutylamine, N,N-diethylmethylamine, N,N-diisopropylethylamine, N,N-dimethylcyclohexylamine, N-methylpiperidine, N-ethylmorpholine or mixtures thereof.

The neutralizing agents specified for preparing the emulsifier molecules C1) comprising sulfonate groups are added in such amounts that the sulfonic acid groups of the starting compounds in the resulting method products according to the invention are neutralized to an extent of at least 20 mol % preferably to an extent of at least 50 mol %, particularly preferably to an extent of at least 90 mol % and especially preferably completely neutralized and are present in the form of sulfonate groups.

The reaction of the polyisocyanate component B) with at least one sulfonic acid bearing at least one isocyanate-reactive group to give an emulsifier molecule C1) is generally carried out at temperatures of 40 to 150° C., preferably 50 to 130° C., while maintaining an equivalence ratio of NCO groups to the sum of hydroxyl, mercapto and amino groups of from 2:1 to 400:1, preferably from 4:1 to 250:1, and may be carried out, for example, according to one of the methods described in EP-A 0 703 255, WO 01/88006, WO 2009/010469 or WO 2015/035673.

Usually, the reaction of the polyisocyanate component B) with at least one sulfonic acid bearing at least one isocyanate-reactive group is carried out in amounts such that the resulting hydrophilically modified polyisocyanate component A) comprises at least 0.90% by weight, preferably at least 0.95% by weight, particularly preferably from 1.00 to 3.00% by weight, especially preferably from 1.10 to 1.80% by weight of sulfonate groups, calculated as SO₃; molar weight=80 g/mol, in chemically bonded form.

The polyisocyanate components B) can be reacted with the hydroxy-, mercapto- and/or aminosulfonic acids mentioned either in a separate reaction step with subsequent mixing of the resulting ionic emulsifiers C1) with the polyisocyanate components B) to be converted to a hydrophilic form, or in such a way that the polyisocyanate components B) are reacted in situ with an appropriate amount of the hydroxy-, mercapto- and/or aminosulfonic acids, whereby a hydrophilic polyisocyanate component A) is formed directly which, in addition to unreacted polyisocyanate B), comprises the emulsifier C1) forming in situ from the hydroxy-, mercapto- and/or aminosulfonic acids, the neutralizing amine and a portion of the components B).

In the first-mentioned variant of the separate preparation of the ionic emulsifiers C1), these are preferably prepared while maintaining an equivalence ratio of isocyanate groups to isocyanate-reactive groups of from 2:1 to 6:1. In the in situ preparation of the emulsifiers C1), it is obviously possible to use a large excess of isocyanate groups within the broad range mentioned above.

Another preferred type of suitable emulsifiers C) are those which comprise both ionic and non-ionic structures in one molecule. These emulsifiers C2) are, for example, alkylphenol polyglycol ether phosphates and phosphonates or fatty alcohol polyglycol ether phosphates and phosphonates neutralized with tertiary amines, such as the neutralizing amines mentioned above, as described for example in WO 97/31960 for the hydrophilization of polyisocyanates, or also alkylphenol polyglycol ether sulfates or fatty alcohol polyglycol ether sulfates neutralized with such tertiary amines.

In this case, the emulsifier component C2) preferably comprises at least one alkali metal or ammonium salt of an alkylphenol polyglycol ether phosphate, alkylphenol polyglycol ether phosphonate, fatty alcohol polyglycol ether phosphate, fatty alcohol polyglycol ether phosphonate, alkylphenol polyglycol ether sulfate and/or fatty alcohol polyglycol ether sulfate.

In addition to the ionic emulsifiers C) mentioned, the hydrophilically modified polyisocyanate components A) present in the polyisocyanate preparations according to the invention may also contain further non-ionic emulsifiers D).

Preferred non-ionic emulsifiers which may optionally be used are, for example, reaction products D1) of the polyisocyanate components B) with hydrophilic polyether alcohols.

Suitable hydrophilic polyether alcohols for this purpose are monohydric or polyhydric polyalkylene oxide polyether alcohols having a statistical average of 5 to 50 ethylene oxide units per molecule, as are accessible in a manner known per se by alkoxylation of suitable starter molecules (for example see Ullmanns Encyclopadie der technischen Chemie [Ullmann's Encyclopedia of Industrial Chemistry], 4th edition, volume 19, Verlag Chemie, Weinheim pp. 31-38). Starter molecules of this kind may be, for example, any desired mono- or polyhydric alcohols of the molecular weight range 32 to 300, such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols, hydroxymethylcyclohexane, 3-methyl-3-hydroxymethyloxetane, benzyl alcohol, phenol, the isomeric cresols, octylphenols, nonylphenols and naphthols, furfuryl alcohol, tetrahydrofurfuryl alcohol, 1,2-ethanediol, 1,2- and 1,3-propanediol, the isomeric butanediols, pentanediols, hexanediols, heptanediols and octanediols, 1,2- and 1,4-cyclohexanediol, 1,4-cyclohexanedimethanol, 4,4′-(1-methylethylidene)biscyclohexanol, 1,2,3-propanetriol, 1,1,1-trimethylolethane, 1,2,6-hexanetriol, 1,1,1-trimethylolpropane, 2,2-bis(hydroxymethyl)-1,3-propane diol or 1,3,5-tris (2-hydroxyethyl) isocy anurate

Alkylene oxides suitable for the alkoxylation reaction are in particular ethylene oxide and propylene oxide, which can be used in the alkoxylation reaction in any desired sequence or else in a mixture. Suitable polyether alcohols are either pure polyethylene oxide polyether alcohols or mixed polyalkylene oxide polyether alcohols, the alkylene oxide units of which consist to an extent of at least 70 mol %, preferably to an extent of at least 80 mol %, of ethylene oxide units.

Preferred polyalkylene oxide polyether alcohols are those which have been produced using the aforementioned monoalcohols of the molecular weight range 32 to 150 as starter molecules. Particularly preferred polyether alcohols are pure polyethylene glycol monomethyl ether alcohols having a statistical average of 5 to 50, especially preferably 5 to 25 ethylene oxide units.

The preparation of such preferred non-ionic emulsifiers D1) to be optionally used is known in principle and described, for example, in EP-B 0 206 059 and EP-B 0 540 985.

As already described for the ionic emulsifiers C1), the reaction of the polyisocyanate components B) with the polyether alcohols mentioned can either be carried out in a separate reaction step with subsequent mixing of the resulting emulsifier D1) with the polyisocyanate components B) to be converted to a hydrophilic form, or in such a way that the polyisocyanate components B) are mixed with an appropriate amount of the polyether alcohols, whereby a hydrophilic polyisocyanate component A) is spontaneously formed which, in addition to unreacted polyisocyanate B), comprises the emulsifier D1) forming in situ from the polyether alcohol and a portion of the component B).

This type of non-ionic emulsifiers D1) is generally prepared at temperatures of 40 to 180° C., preferably 50 to 150° C., while maintaining an NCO/OH equivalence ratio of from 2:1 to 400:1, preferably from 4:1 to 140:1.

In the first-mentioned variant of the separate preparation of the non-ionic emulsifiers D1), these are preferably prepared while maintaining an NCO/OH equivalence ratio of from 2:1 to 6:1. In the in situ preparation of the emulsifiers D1), it is obviously possible to use a large excess of isocyanate groups within the broad range mentioned above.

The reaction of the polyisocyanate component B) with the hydrophilic polyether alcohols mentioned can also be carried out according to the process described in EP-B 0 959 087 in such a way that the urethane groups primarily formed by the NCO/OH reaction are further converted, at least partially, preferably to an extent of at least 60 mol %, to allophanate groups, based on the sum of urethane and allophanate groups, forming a non-ionic emulsifier D2). In this case, the reaction partners are reacted at the aforementioned NCO/OH equivalence ratio at temperatures of 40 to 180° C., preferably 50 to 150° C., usually in the presence of the catalysts suitable for accelerating the allophanation reaction, as indicated in the cited patent specifications, in particular zinc compounds, such as zinc(II) n-octanoate, zinc(II) 2-ethyl-1-hexanoate or zinc(II) stearate.

Another preferred type of non-ionic emulsifiers D) to be optionally used are also, for example, reaction products of monomeric diisocyanates or diisocyanate mixtures with the aforementioned monohydric or polyhydric hydrophilic polyether alcohols at an OH/NCO equivalence ratio of from 0.6: 1 to 1.2:1. Particular preference is given to the reaction of monomeric diisocyanates or diisocyanate mixtures with pure polyethylene glycol monoalkyl ether alcohols having a statistical average of 5 to 50, preferably 5 to 25, ethylene oxide units. The preparation of such emulsifiers D3) is also known and is described, for example, in EP-B 0 486 881.

Optionally, however, the emulsifiers D3) may also be reacted with the polyisocyanates B) with allophanation in the presence of suitable catalysts after the components have been mixed in the ratios described above. This also produces hydrophilic polyisocyanate components A) which, in addition to unreacted polyisocyanate B), comprise a further non-ionic emulsifier type D4) having an allophanate structure which forms in situ from the emulsifier D3) and a portion of the component B). The in situ preparation of such emulsifiers D4) is also already known and is described, for example, in WO 2005/047357.

Irrespective of the type of emulsifiers C) and D) and the preparation thereof, the amount thereof or the amount of the ionic and optionally non-ionic components added to the polyisocyanates B) during an in situ preparation of the emulsifiers is generally measured such that the hydrophilically modified polyisocyanate compositions A) finally obtained comprise an amount of emulsifier C) and optionally D) which ensures the dispersibility of the polyisocyanate mixture.

When non-ionic emulsifiers D) are used, the sequence of the hydrophilization can be freely selected. Thus, the addition or in situ preparation of the non-ionic emulsifiers D) can take place at any point in time before, during or after the addition or in situ preparation of the ionic emulsifiers C).

In addition to the ionically hydrophilically modified polyisocyanate component A), the polyisocyanate preparations according to the invention comprise at least one solvent component E) consisting of at least one organic solvent and having a peroxide content of at most 70 mg/l H₂O₂, preferably at most 60 mg/l H₂O₂ and particularly preferably at most 50 mg/l H₂O₂.

Suitable organic solvents are in principle all solvents that are chemically inert to isocyanate groups, i.e. those which do not have isocyanate-reactive groups, such as hydroxyl or amino groups.

Such organic solvents are, for example, the typical paint solvents known per se, such as methyl acetate, ethyl acetate, n-propyl acetate, isopropyl acetate, butyl acetate, isobutyl acetate, t-butyl acetate, amyl acetate, 2-methylpentyl acetate, 2-ethylhexyl acetate, ethylene glycol diacetate, propylene glycol diacetate, n-propyl propionate, n-butyl propionate, n-pentyl propionate, methyl esters of glutaric acid, succinic acid and adipic acid known as dibasic esters (DBE), which are often also present as a mixture, acetone, 2-butanone (MEK), 2-pentanone, 4-methyl-2-pentanone (MIBK), 2-heptanone, 5-methylhexan-2-one, 2,6-dimethylheptan-4-one, cyclohexanone, toluene, xylene, chlorobenzene, white spirit, higher substituted aromatics, such as those sold under the names Solventnaphtha, Solvesso®, Isopar®, Nappar® (Deutsche EXXON CHEMICAL GmbH, Cologne, Del.) and Shellsol® (Deutsche Shell Chemie GmbH, Eschborn, DE), carbonic acid esters such as dimethyl carbonate, diethyl carbonate, 1,2-ethylene carbonate and 1,2-propylene carbonate, lactones such as β-propiolactone, γ-butyrolactone, e-caprolactone and s-methylcaprolactone, acetals such as 1,1,2,2-tetramethoxyethane, 1,1,2,2-tetraethoxyethane, ethyl 2,2-dimethoxyacetate or methyl 2,2-diethoxyacetate, solvents such as diethylene glycol dimethyl ether, dipropylene glycol dimethyl ether, ethylene glycol methyl ether acetate, ethylene glycol ethyl ether acetate, ethylene glycol butyl ether acetate, diethylene glycol butyl ether acetate, dipropylene glycol methyl ether acetate, dipropylene glycol ethyl ether acetate, 1-methoxy-2-propyl acetate (MPA), 3-methoxy-n-butyl acetate, tetrahydrofuran, 1,3-dioxolane, N,N-dimethylformamide, N-methylpyrrolidone and N-methylcaprolactam, or special fluorinated solvents such as p-chlorobenzotrifluoride (PCBTF; OXSOL® 100) or mixtures of at least two such solvents.

For use in the solvent component E), these solvents preferably have a water content of at most 500 ppm. For such low-water solvents, terms such as “urethane grade” or “PU quality” have become established on the market.

According to the invention, the peroxide content in the solvent component E) is at most 70 mg/l H₂O₂, preferably at most 60 mg/l H₂O₂ and particularly preferably at most 50 mg/l H₂O₂. Due to the fact that complete absence of peroxide in paint solvents can only be achieved in practice with considerable effort and expense, the peroxide content in the solvent component E) is preferably at most 60 mg/l H₂O₂, particularly preferably at most 50 mg/l H₂O₂, especially preferably from 1 to 30 mg/l H₂O₂, even more preferably from 1 to 25 mg/l H₂O₂ and especially from 2 to 10 mg/l H₂O₂, these values being the average peroxide content of all the organic solvents present in the solvent component E).

The hydrophilically modified polyisocyanate component A) and the solvent component E) are present in the polyisocyanate preparations according to the invention in such amounts that the calculated peroxide content of the polyisocyanate preparations immediately after mixing is at most 20 mg/l H₂O₂, preferably 1 to 20 mg/l H₂O₂, particularly preferably 1 to 18 mg/l H₂O₂ and especially preferably 1 to 15 mg/l H₂O₂, based in each case on the sum of A) and E).

The proportion of the solvent component E) in the polyisocyanate preparations according to the invention is generally 5 to 90% by weight, preferably 10 to 80% by weight, particularly preferably 15 to 70% by weight and especially preferably 20 to 60% by weight, of the total amount of the components A) and E).

In the context of the present application, the peroxide content was determined using commercially available peroxide test strips. Suitable test strips are, for example, MQuant® Peroxide test strips from Merck KgaA, Darmstadt, Germany or Quantofix® Peroxide test strips from MACHEREY-NAGEL GmbH & Co. KG, Duren, Germany.

The reaction principle underlying these test strips is that peroxide oxygen is transferred enzymatically by means of a peroxidase to an organic redox indicator in the reaction zone, resulting in a colored oxidation product. The peroxide concentration is determined semi-quantitatively by visually assessing the reaction zone of the test strip using the fields on a color scale. There are different test strips with differently graded color scales for different concentration ranges. Test strips of Merck article number 10011.0001. cover, for example, the range 0.5-2-5-10-25 mg/L peroxide, those of Merck article number 1.10081.0001. the range 1-3-10-30-100 mg/L peroxide, those of Merck article number 1.10337.0001. the range 100-200-400-600-800-1000 mg/L peroxide, test strips of MACHEREY-NAGEL article number REF 913 19 the range 0-0.5-2-5-10-25 mg/L peroxide, those of MACHEREY-NAGEL article number REF 913 12 the range 0-1-3-10-30-100 mg/L peroxide and those of MACHEREY-NAGEL article number REF 913 33 the range 0-50-150-300-500-800-1000 mg/L peroxide, where the peroxide specification corresponds in each case to a hydrogen peroxide equivalent.

Thus, a preferred embodiment of the invention is a polyisocyanate preparation comprising at least one polyisocyanate component A) hydrophilically modified with at least one ionic emulsifier, and a solvent component E) consisting of at least one organic solvent, characterized in that the solvent component E) has a peroxide content, determined by peroxide test strips, of at most 70 mg/l H₂O₂ equivalents, preferably of at most 60 mg/l H₂O₂ equivalents and particularly preferably of at most 50 mg/l H₂O₂ equivalents, wherein this value is the average peroxide content of all organic solvents present in the solvent component E), and the polyisocyanate component A) and the solvent component E) are present in amounts such that the calculated peroxide content of the polyisocyanate preparation is at most 20 mg/l H₂O₂, based on the sum of A) and E). Here, too, the preferred embodiments mentioned in subclaims 2 to 12 are equally preferred. This embodiment can also be the basis of the use, coating composition and coated substrate according to the invention.

The preparation of the polyisocyanate preparations according to the invention from the hydrophilically modified polyisocyanate component A) and the solvent component E) can be carried out by simple mixing by hand or with the aid of suitable mixing units, preferably at temperatures from 0 to 60° C., optionally already during the preparation of the hydrophilically modified polyisocyanate component A) or at any time thereafter up to immediately prior to the use thereof in accordance with the invention.

When using solvent components E), the peroxide content of which is at most 70 mg/l H₂O₂, preferably at most 60 mg/l H₂O₂ and particularly preferably at most 50 mg/l H₂O₂, the polyisocyanate preparations according to the invention obtained in this way are clear, transparent polyisocyanate solutions having Hazen color indices of less than 60, preferably less than 40, particularly preferably less than 30, and do not exceed these even after prolonged storage of 5 days at 50° C. The Hazen color indices are measured spectrophotometrically in this case in accordance with DIN EN ISO 6271-2:2005-03.

The solvent-containing polyisocyanate preparations according to the invention can readily be converted to preferably sedimentation-stable dispersions without using high shear forces by merely stirring into water.

Optionally, prior to the emulsification, any further non-hydrophilized polyisocyanates can be added thereto, for example those of the type specified as suitable polyisocyanate component B), whereby polyisocyanate preparations are obtained which, provided that the specifications given above with respect to the proportion of the solvent component E) and the peroxide content thereof are observed, are also polyisocyanate preparations according to the invention since these generally consist of mixtures of
(i) a hydrophilically modified polyisocyanate component A) comprising at least one polyisocyanate component B) and at least one ionic and optionally non-ionic emulsifier C), and
(ii) a solvent component E) of the type mentioned by way of example.

In such mixtures, the emulsifiers C) present in the polyisocyanate preparations according to the invention also assume the function of an emulsifier for the proportion of non-hydrophilic polyisocyanates B) subsequently mixed in.

The solvent-containing polyisocyanate preparations according to the invention represent valuable starting materials for the production of polyurethane plastics by the isocyanate polyaddition process.

For this purpose, the polyisocyanate preparations are preferably used in the form of aqueous emulsions which can be reacted in combination with polyhydroxyl compounds dispersed in water in the context of aqueous two-component systems.

The solvent-containing polyisocyanate preparations according to the invention are particularly preferably used as crosslinkers for paint binders or paint binder components, dissolved or dispersed in water, that have groups reactive to isocyanate groups, especially alcoholic hydroxyl groups, in the production of coatings using aqueous coating compositions based on such binders or binder components. The crosslinker, optionally in emulsified form, can be combined with the binders or binder components here by simple stirring by any methods prior to processing the coating compositions or even by using two-component spray guns.

Paint binders or paint binder components which may be mentioned in this context include: polyacrylates comprising hydroxyl groups, dissolved or dispersed in water, especially those of the molecular weight range 1000 to 20 000, which are valuable two-component binders with organic polyisocyanates as crosslinkers, or optionally urethane-modified polyester resins comprising hydroxyl groups, dispersed in water, of the type known from polyester and alkyd resin chemistry. In principle, suitable as reaction partners for the polyisocyanate mixtures according to the invention are any binders, dissolved or dispersed in water, comprising groups that are reactive to isocyanates. These also include, for example, polyurethanes or polyureas dispersed in water, which can be crosslinked with polyisocyanates due to the active hydrogen atoms present in the urethane or urea groups.

The present invention further provides a coating composition comprising at least one solvent-containing polyisocyanate preparation according to the invention.

When used according to the invention as crosslinker component for aqueous paint binders, the solvent-containing polyisocyanate preparations according to the invention are generally used in such amounts that correspond to an equivalence ratio of NCO groups to groups that are reactive to NCO groups, especially alcoholic hydroxyl groups, from 0.5:1 to 2:1.

The solvent-containing polyisocyanate preparations according to the invention may optionally also be admixed in minor amounts with non-functional aqueous paint binders, for the purpose of achieving very specific properties, as an additive for improving adhesion, for example.

The solvent-containing polyisocyanate preparations according to the invention can of course also be used in a form in which they are blocked with blocking agents known per se from polyurethane chemistry, in combination with the aforementioned aqueous paint binders or paint binder components, as aqueous one-component PUR baking systems. Suitable blocking agents are, for example, diethyl malonate, ethyl acetoacetate, acetone oxime, butanone oxime, ε-caprolactam, 3,5-dimethylpyrazole, 1,2,4-triazole, dimethyl-1,2,4-triazole, imidazole or mixtures of at least two of these blocking agents.

Substrates contemplated for the aqueous coatings formulated using the solvent-containing polyisocyanate preparations according to the invention include any desired substrates, for example metal, wood, glass, stone, ceramic materials, concrete, rigid and flexible plastics, textiles, leather, and paper, which prior to coating may optionally also be provided with customary primers. A preferred field of application for the solvent-containing polyisocyanate preparations according to the invention are aqueous two-component varnishes for varnishing wood and furniture.

In general, the aqueous coating compositions formulated with the solvent-containing polyisocyanate preparations according to the invention, to which the auxiliaries and additives customary in the coatings sector may optionally be incorporated, examples being flow control assistants, dyes, color pigments, fillers or matting agents, have good technical coatings properties even when dried at room temperature.

Of course, they may alternatively be dried under forced conditions at elevated temperature or by baking at temperatures up to 260° C.

The present invention further provides a substrate coated with a coating composition according to the invention optionally cured by the action of heat.

Due to their low intrinsic color, the use of the solvent-containing polyisocyanate preparations according to the invention as crosslinker component for aqueous polyurethane coatings results in coatings which, applied as clearcoats, do not adversely affect the color shade of the substrate or the basecoat or, in pigmented coatings, the pigment color shade.

In addition to their preferred use as crosslinker components for aqueous 2K-PUR coatings, the solvent-containing polyisocyanate preparations according to the invention are outstandingly suitable as crosslinkers for aqueous dispersion adhesives, leather and textile coatings, textile printing pastes or as AOX-free paper auxiliaries.

The features specified as preferred for the solvent-containing polyisocyanate preparations according to the invention are also preferred for the further subject matter of the invention.

The invention in a first embodiment relates to a polyisocyanate preparation comprising at least one polyisocyanate component A) hydrophilically modified with at least one ionic emulsifier and a solvent component E) consisting of at least one organic solvent, characterized in that the solvent component E) has a peroxide content of at most 70 mg/l H₂O₂ equivalents, preferably of at most 60 mg/l H₂O₂ equivalents and particularly preferably of at most 50 mg/l H₂O₂ equivalents, wherein this value is the average peroxide content of all organic solvents present in the solvent component E), and the polyisocyanate component A) and the solvent component E) are present in amounts such that the calculated peroxide content of the polyisocyanate preparation is at most 20 mg/l H₂O₂, based on the sum of A) and E).

In a second embodiment, the invention relates to a polyisocyanate preparation according to embodiment 1, characterized in that the hydrophilically modified polyisocyanate component A) consists of a polyisocyanate component B) and at least one ionic emulsifier C).

In a third embodiment, the invention relates to a polyisocyanate preparation according to embodiment 1 or 2, characterized in that the polyisocyanate component B) is any diisocyanates, triisocyanates and/or polyisocyanates having aliphatically, cycloaliphatically, araliphatically and/or aromatically bonded isocyanate groups.

In a fourth embodiment, the invention relates to a polyisocyanate preparation according to any of embodiments 1 to 3, characterized in that the polyisocyanate component B) was prepared by modifying PDI, HDI, IPDI, 4,4′-diisocyanatodicyclohexylmethane, XDI, 2,4- and/or 2,6-TDI.

In a fifth embodiment, the invention relates to a polyisocyanate preparation according to any of embodiments 1 to 4, characterized in that the polyisocyanate component B) comprises isocyanurate group-containing polyisocyanates based on PDI, HDI and/or IPDI and/or urethane group-containing TDI polyisocyanates, in particular low-monomer reaction products of 2,4- and/or 2,6-TDI with 1,1,1-trimethylolpropane (TMP) and optionally further preferably low molecular weight alcohols in the molecular weight range from 62 to 194 g/mol, such as diethylene glycol for example

In a sixth embodiment, the invention relates to a polyisocyanate preparation according to any of embodiments 1 to 5, characterized in that the ionic emulsifiers C) are reaction products of polyisocyanate components B) with organic compounds bearing at least one isocyanate-reactive group and at least one sulfonic acid or sulfonate group.

In a seventh embodiment, the invention relates to a polyisocyanate preparation according to any of embodiments 1 to 6, characterized in that the ionic emulsifiers C) are reaction products of polyisocyanate components B) with amino-functional sulfonic acids of the general formula (III) and/or salts thereof,

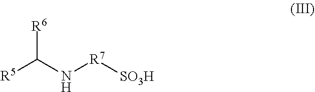

wherein in formula (III) R⁵ and R⁶ are each independently identical or different radicals and are hydrogen or saturated or unsaturated, linear or branched, aliphatic or cycloaliphatic or aromatic organic radicals having 1 to 18 carbon atoms, which are substituted or unsubstituted and/or comprise heteroatoms in the chain, wherein R⁵ and R⁶, in combination with each other and optionally one further nitrogen atom or one oxygen atom, may also form cycloaliphatic or heterocyclic rings having 3 to 8 carbon atoms, which may optionally be further substituted, and R⁷ is a linear or branched aliphatic radical having 2 to 6 carbon atoms.

In an eighth embodiment, the invention relates to a polyisocyanate preparation according to any of embodiments 1 to 7, characterized in that the ionic emulsifiers C) are reaction products of polyisocyanate components B) with 2-isopropylaminoethane-1-sulfonic acid, 3-isopropylaminopropane-1-sulfonic acid, 4-isopropylaminobutane-1-sulfonic acid, 2-cyclohexylaminoethane-1-sulfonic acid, 3-cyclohexylaminopropane-1-sulfonic acid and/or 4-acid and/or salts thereof.

In a ninth embodiment, the invention relates to a polyisocyanate preparation according to any of embodiments 5 to 8, characterized in that the polyisocyanate component A) comprises at least 0.95% by weight, particularly preferably from 1.00 to 3.00% by weight, especially preferably from 1.10 to 1.80% by weight of sulfonate groups, calculated as SO₃; molar weight=80 g/mol, in chemically bonded form.

In a tenth embodiment, the invention relates to a polyisocyanate preparation according to any of embodiments 1 to 9, characterized in that the solvent component E) consists of at least one organic solvent and has a peroxide content of at most 60 mg/l H₂O₂, particularly preferably at most 50 mg/l H₂O₂, especially preferably from 1 to 30 mg/l H₂O₂, even more preferably from 1 to 25 mg/l H₂O₂ and especially from 2 to 10 mg/l H₂O₂, wherein these values are the average peroxide content of all organic solvents present in the solvent component E).

In an eleventh embodiment, the invention relates to a polyisocyanate preparation according to any of embodiments 1 to 10, characterized in that the polyisocyanate component A) and the solvent component E) are present in amounts such that the calculated peroxide content of the polyisocyanate preparation, based on the sum of A) and E), is 1 to 20 mg/l H₂O₂, preferably 1 to 18 mg/l H₂O₂, particularly preferably 1 to 15 mg/l H₂O₂.

In a twelfth embodiment, the invention relates to a polyisocyanate preparation according to any of embodiments 1 to 11, characterized in that the proportion of the solvent component E) is 5 to 90% by weight, preferably 10 to 80% by weight, particularly preferably 15 to 70% by weight and especially preferably 20 to 60% by weight, of the total amount of the components A) and E).

In a thirteenth embodiment, the invention relates to the use of the polyisocyanate preparation according to any of embodiments 1 to 12 as a starting component in the production of polyurethane plastics.

In a fourteenth embodiment, the invention relates to a coating composition comprising at least one polyisocyanate preparation according to any of embodiments 1 to 12.

In a fifteenth embodiment, the invention relates to a substrate coated with a coating composition according to embodiment 14, optionally cured under the action of heat.

The examples which follow serve to illustrate the present invention, but should in no way be understood as imposing any restriction on the scope of protection.

### EXAMPLES

All percentages are based on weight unless otherwise stated.

NCO contents were determined titrimetrically to DIN EN ISO 11909:2007-05.

All viscosity measurements were recorded using a Physica MCR 51 rheometer from Anton Paar Germany GmbH (Germany) to DIN EN ISO 3219:1994-10 at a shear rate of 250 s⁻¹.

Residual monomer contents were measured in accordance with DIN EN ISO 10283:2007-11 by gas chromatography with internal standard.

The color indices (Hazen color index according to DIN EN ISO 6271-2:2005-03, iodine color index according to DIN 6162:2014-09) were measured spectrophotometrically using a LICO 690 spectral colorimeter from Hach Lange, Germany.

The peroxide content was determined using commercially available peroxide test strips. Suitable test strips are, for example, MQuant® Peroxide test strips from Merck KgaA, Darmstadt, Germany or Quantofix® Peroxide test strips from MACHEREY-NAGEL GmbH & Co. KG, Duren, Germany. The reaction principle underlying these test strips is that peroxide oxygen is transferred enzymatically by means of a peroxidase to an organic redox indicator in the reaction zone, resulting in a colored oxidation product. The peroxide concentration is determined semi-quantitatively by visually assessing the reaction zone of the test strip using the fields on a color scale. There are different test strips with differently graded color scales for different concentration ranges. Test strips of Merck article number 10011.0001. cover, for example, the range 0.5-2-5-10-25 mg/L peroxide, those of Merck article number 1.10081.0001. the range 1-3-10-30-100 mg/L peroxide, those of Merck article number 1.10337.0001. the range 100-200-400-600-800-1000 mg/L peroxide and test strips of Macherey-Nagel article number REF 913 33 the range 0-50-150-300-500-800-1000 mg/L peroxide, where the peroxide specification corresponds in each case to a hydrogen peroxide equivalent.

### Starting Compounds

### Solvent Components E)

### Solvent E1)

### 1-Methoxy-2-propyl acetate (MPA)

5 1 plastic container, supplier: Azelis Deutschland GmbH (formerly Kraemer & Martin GmbH), Sankt Augustin, Germany

Quality 1: Peroxide content ca. 3 mg/l H₂O₂ equivalents

Quality 2: Peroxide content ca. 30 mg/l H₂O₂ equivalents

Quality 3: Peroxide content ca. 50 mg/l H₂O₂ equivalents

Quality 4: Peroxide content ca. 100 mg/l H₂O₂ equivalents

Quality 5: Peroxide content ca. 150 mg/l H₂O₂ equivalents

### Solvent E2)

3-Methoxy-n-butyl acetate (Butoxyl)

500 ml glass bottle, supplier: abcr GmbH, Karlsruhe, Germany

Quality 1: Peroxide content ca. 3 mg/l H₂O₂ equivalents

Quality 2: Peroxide content ca. 50 mg/l H₂O₂ equivalents

Quality 3: Peroxide content ca. 60 mg/l H₂O₂ equivalents

Quality 4: Peroxide content ca. 100 mg/l H₂O₂ equivalents

### Solvent E3)

### Solvent Light Naphtha

5 1 plastic container, supplier: Azelis Deutschland GmbH, Sankt Augustin, Germany

Quality 1: Peroxide content ca. 3 mg/l H₂O₂ equivalents

Quality 2: Peroxide content ca. 30 mg/l H₂O₂ equivalents

Quality 3: Peroxide content ca. 50 mg/l H₂O₂ equivalents

Quality 4: Peroxide content ca. 60 mg/l H₂O₂ equivalents

Quality 5: Peroxide content ca. 150 mg/l H₂O₂ equivalents

### Polyisocyanate Components B)

### Polyisocyanate Component B1)

HDI polyisocyanate comprising isocyanurate groups, produced by catalytic trimerization of HDI based on Example 11 of EP-A 330 966, with the modification that the reaction was stopped by addition of dibutyl phosphate at an NCO content of the crude mixture of 40%. Subsequently, unconverted HDI was removed by thin-film distillation at a temperature of 130° C. and a pressure of 0.2 mbar.

NCO content: 21.7%

NCO functionality: 3.4

Monomeric HDI: 0.1%

Viscosity (23° C.): 3080 mPas

Color index (Hazen): 18

### Polyisocyanate Component B2)

PDI polyisocyanate comprising isocyanurate groups, produced by catalytic trimerization of PDI by the method described in WO 2016/146579 for the polyisocyanate component A2). The reaction was deactivated at an NCO content of the crude mixture of 36.7% by addition of an equimolar amount of dibutyl phosphate, based on the amount of catalyst used, and further stirring for 30 minutes at 80° C. Subsequently, unconverted PDI was removed by thin-film distillation at a temperature of 140° C. and a pressure of 0.5 mbar.

NCO content: 21.8%

NCO functionality: 3.5

Monomeric PDI: 0.09%

Viscosity (23° C.): 9850 mPas

Color index (Hazen): 34

### Polyisocyanate Component B3)

Urethane group-containing TDI polyisocyanate, produced based on Example 4 of EP-A 0 546 399, with the modification that a mixture of 80% 2,4-TDI and 20% 2,6-TDI is used and the resulting pale yellow resin is dissolved at 60% strength in 1-methoxy-2-propyl acetate (MPA, peroxide content 3 mg/l H₂O₂).

NCO content: 10.6%

NCO functionality: 3.3

Monomeric 2,4-TDI: 0.13%

Monomeric 2,6-TDI: 0.14%

Viscosity (23° C.): 370 mPas

Color index (Hazen): 34

### Polyisocyanate Component A1)

(emulsifier type C1))

943.9 g (4.88 val) of the polyisocyanate component B1) were stirred together with 36.0 g (0.16 val) of 3-(cyclohexylamino)propanesulfonic acid (CAPS), 20.1 g (0.16 mol) of dimethylcyclohexylamine and 0.05 g (50 ppm) of 2,6-di-tert-butyl-4-methylphenol under dry nitrogen at 100° C. for 4:00 hours until a substantially clear polyisocyanate mixture comprising sulfonate groups was obtained. After cooling to room temperature and filtration over a T 5500 filter layer (Seitz), the following characteristic data were determined:

NCO content: 19.8%

NCO functionality: 3.3

Color index (Hazen):

Polyisocyanate component A2)

(emulsifier type C2))

890 g (4.60 val) of the polyisocyanate component B1) were stirred at 80° C. for 12 hours with 110 g of an emulsifier mixture consisting of 97 g of an ethoxylated tridecyl alcohol phosphate (Rhodafac® RS-710, from Solvay) and 13 g of dimethylcyclohexylamine as the neutralizing amine After cooling to room temperature, a clear polyisocyanate mixture is present having the following characteristic data:

NCO content: 19.3%

NCO functionality: 3.5

Viscosity (23° C.): 9200 mPas

Color index (Hazen): 33

Polyisocyanate component A3)

(emulsifier type C1))

960.7 g (4.98 val) of the polyisocyanate component B2) were stirred together with 25.0 g (0.11 val) of 3-(cyclohexylamino)propanesulfonic acid (CAPS), 14.3 g (0.11 mol) of dimethylcyclohexylamine and 0.05 g (50 ppm) of 2,6-di-tert-butyl-4-methylphenol at 100° C. under dry nitrogen for 3:30 hours until a largely clear polyisocyanate mixture containing sulfonate groups was obtained. After cooling to room temperature and filtration over a T 5500 filter layer (Seitz), the following characteristic data were determined:

NCO content: 20.5%

NCO functionality: 3.3

Viscosity (23° C.): 4050 mPas

Color index (Hazen): 18

### Polyisocyanate Component A4)

(emulsifier type C1))

700 g (2.88 val) of the hydrophilic polyisocyanate component A1) were mixed with 300 g (0.76 val) of the polyisocyanate component B3) at 30° C. and homogenized by stirring for 30 minutes. A mixed aliphatic/aromatic polyisocyanate having the following characteristic data was obtained:

NCO content: 15.2%

NCO functionality: 3.2

Solids content: 88%

Viscosity (23° C.): 6800 mPas

Color index (Hazen): 29

Polyisocyanate component A5)

(emulsifier type C1) and D1))

900.0 g (4.65 val) of the polyisocyanate component B1) were stirred together with 30.0 g (0.14 val) of 3-(cyclohexylamino)propanesulfonic acid (CAPS), 17.8 g (0.14 mol) of dimethylcyclohexylamine, 52.2 g (0.10 mol) of a methanol-initiated, monofunctional polyethylene oxide polyether of average molecular weight 500 and 0.05 g (50 ppm) of 2,6-di-tert-butyl-4-methylphenol at 100° C. under dry nitrogen for 6:00 hours until a clear polyisocyanate mixture containing sulfonate groups and polyether units was obtained. After cooling to room temperature and filtration over a T 5500 filter layer (Seitz), the following characteristic data were determined:

NCO content: 18.5%

NCO functionality: 3.2

Viscosity (23° C.): 4660 mPas

Color index (Hazen): 12

### Comparative Polyisocyanate A6)

(emulsifier type D1))

870 g (4.50 val) of the polyisocyanate component B1) were initially charged at 100° C. under dry nitrogen and stirred, and 130 g (0.37 val) of a methanol-initiated, monofunctional polyethylene oxide polyether having an average molecular weight of 350 were added over 30 minutes and stirring was continued at this temperature until the NCO content of the mixture had fallen to a value of 17.4% after about 2 hours. After cooling to room temperature, there was a colorless, clear polyisocyanate mixture having the following characteristic data:

NCO content: 17.4%

NCO functionality: 3.2

Viscosity (23° C.): 2960 mPas

Color index (Hazen): 26

### Polyisocyanate Preparations 1 to 14 (Inventive and Comparative)

In each case 100 parts by weight of the polyisocyanate component A4) were mixed at room temperature with 46.7 g each of different qualities of the solvents El) to E3) and the mixtures homogenized by stirring for 30 minutes.

Tables 1 to 3 show the color indices of the 60% strength polyisocyanate preparations obtained as a function of the peroxide content of the particular solvent and that of the polyisocyanate solution after storage for 24 hours at room temperature.

TABLE 1
Polyisocyanate preparations with 1-methoxy-
2-propyl acetate (solvent E1))

| | | | | | 4 | 5 |
|---|---|---|---|---|---|---|
| Polyisocyanate | | | | | compar- | compar- |
| preparation | | 1 | 2 | 3 | ative | ative |
| Polyisocyanate | | A4) | A4) | A4) | A4) | A4) |
| component | | | | | | |
| Solvent E1), quality | | 1 | 2 | 3 | 4 | 5 |
| Peroxide content of | [mg/l | 3 | 30 | 50 | 100 | 150 |
| solvent E1) | H₂O₂] | | | | | |
| Total peroxide | [mg/l | 3 | 24 | 40 | 80 | 120 |
| content of solvents*⁾ | H₂O₂] | | | | | |
| Peroxide content of | [mg/l | 1 | 10 | 16 | 32 | 48 |
| polyisocyanate | H₂O₂] | | | | | |
| solution*⁾ | | | | | | |
| Color index after | Hazen | 22 | 25 | 45 | 893 | >1000 |
| 24 h/25° C. | Iodine | 0.1 | 0.1 | 0.2 | 5.3 | 9.5 |

*⁾calculated value

TABLE 2
Polyisocyanate preparations with 3-methoxy-
n-butyl acetate (solvent E2))

| | | | | | 9 |
|---|---|---|---|---|---|
| Polyisocyanate | | | | | compar- |
| preparation | | 6 | 7 | 8 | ative |
| Polyisocyanate | | A4) | A4) | A4) | A4) |
| component | | | | | |
| Solvent E2), quality | | 1 | 2 | 3 | 4 |
| Peroxide content of | [mg/l | 3 | 50 | 60 | 100 |
| solvent E2) | H₂O₂] | | | | |
| Total peroxide content | [mg/l | 3 | 40 | 48 | 80 |
| of solvents*⁾ | H₂O₂] | | | | |
| Peroxide content of | [mg/l | 1 | 16 | 19 | 32 |
| polyisocyanate | H₂O₂] | | | | |
| solution*⁾ | | | | | |
| Color index after | Hazen | 24 | 48 | 51 | 914 |
| 24 h/25° C. | Iodine | 0.1 | 0.2 | 0.2 | 5.5 |

*⁾calculated value

TABLE 3
Polyisocyanate preparations with solvent naphtha 100 (solvent E3))

| | | | | | | 14 |
|---|---|---|---|---|---|---|
| Polyisocyanate | | | | | | compar- |
| preparation | | 10 | 11 | 12 | 13 | ative |
| Polyisocyanate | | A4) | A4) | A4) | A4) | A4) |
| component | | | | | | |
| Solvent E3), quality | | 1 | 2 | 3 | 4 | 5 |
| Peroxide content of | [mg/l | 3 | 30 | 50 | 60 | 150 |
| solvent E1) | H₂O₂] | | | | | |
| Total peroxide | [mg/l | 3 | 24 | 40 | 48 | 120 |
| content of solvents*⁾ | H₂O₂] | | | | | |
| Peroxide content of | [mg/l | 1 | 10 | 16 | 19 | 48 |
| polyisocyanate | H₂O₂] | | | | | |
| solution*⁾ | | | | | | |
| Color index after | Hazen | 24 | 28 | 50 | 58 | >1000 |
| 24 h/25° C. | Iodine | 0.1 | 0.1 | 0.2 | 0.3 | 12.1 |

*⁾calculated value

### Polyisocyanate Preparations 15 to 25 (Inventive and Comparative)

In each case 100 parts by weight of the polyisocyanate components A1), A2), A3) and A5) were mixed at room temperature with 42.8 g each of different qualities of the solvents E1) to E3) and the mixtures homogenized by stirring for 30 minutes.

Table 4 shows the color indices of the 70% strength polyisocyanate preparations obtained as a function of the peroxide content of the particular solvent and that of the polyisocyanate solution after storage at 50° C. for 5 days.

### Polyisocyanate Preparations 16 to 34 (Inventive and Comparative)

Polyisocyanate component A1) was mixed at room temperature with different amounts of different qualities of the solvent E1) and homogenized by stirring for 30 minutes.

Table 5 shows the compositions and solids contents of the polyisocyanate preparations obtained and their color indices as a function of the peroxide content of the solvent and that of the polyisocyanate solution after storage at 50° C. for 5 days.

TABLE 4
Polyisocyanate preparations 15 to 25

| Polyisocyanate | | | 16 | | | 19 | | 21 | | 23 | | 25 |
|---|---|---|---|---|---|---|---|---|---|---|---|---|
| preparation | | 15 | comparative | 17 | 18 | comparative | 20 | comparative | 22 | comparative | 24 | comparative |
| Polyisocyanate | | A1) | A1) | A1) | A1) | A1) | A2) | A2) | A3) | A3) | A5) | A5) |
| component | | | | | | | | | | | | |
| Solvent E1), quality | | 3 | 4 | — | — | — | — | — | 3 | 4 | 3 | 4 |
| Solvent E2), quality | | — | — | — | — | — | 3 | 4 | — | — | — | — |
| Solvent E3), quality | | — | — | 3 | 4 | 5 | — | — | — | — | — | — |
| Peroxide content | [mg/l H₂O₂] | 50 | 100 | 50 | 60 | 150 | 60 | 100 | 50 | 100 | 50 | 100 |
| of solvent | | | | | | | | | | | | |
| Peroxide content of | [mg/l H₂O₂] | 15 | 30 | 15 | 18 | 45 | 18 | 30 | 15 | 30 | 15 | 30 |
| polyisocyanate | | | | | | | | | | | | |
| solution^{*)} | | | | | | | | | | | | |
| Color index after | Hazen | 14 | 107 | 17 | 20 | 216 | 29 | 128 | 20 | 138 | 18 | 112 |
| 5 d/50° C. | | | | | | | | | | | | |
| | Iodine | 0 | 0.5 | 0 | 0 | 1.2 | 0.1 | 0.7 | 0 | 0.7 | 0 | 0.6 |

*⁾calculated value

TABLE 5
Polyisocyanate preparations 26 to 34

| | | | | | | 31 | | | 34 |
|---|---|---|---|---|---|---|---|---|---|
| Polyisocyanate preparation | | 26 | 27 | 28 | 30 | comparative | 32 | 33 | comparative |
| Polyisocyanate component A1) | [parts by wt.] | 70 | 60 | 50 | 40 | 30 | 70 | 60 | 50 |
| Solvent E1), quality 3 | [parts by wt.] | — | — | — | — | — | 30 | 40 | 50 |
| Solvent E1), quality 2 | [parts by wt.] | 30 | 40 | 50 | 60 | 70 | — | — | — |
| Solids content | [%] | 70 | 60 | 50 | 40 | 30 | 70 | 60 | 50 |
| Peroxide content of solvent | [mg/l H₂O₂] | 30 | 30 | 30 | 30 | 30 | 50 | 50 | 50 |
| Peroxide content of | [mg/l H₂O₂] | 9 | 12 | 15 | 18 | 21 | 15 | 20 | 25 |
| polyisocyanate solution^{*)} | | | | | | | | | |
| Color index after 5 d/50° C. | Hazen | 9 | 12 | 15 | 28 | 65 | 14 | 34 | 83 |
| | Iodine | 0 | 0 | 0 | 0.1 | 0.3 | 0 | 0.1 | 0.4 |

*⁾calculated value

### Polyisocyanate Preparation 35 (Comparative)

100 parts by weight of the polyisocyanate component A6) were mixed at room temperature with 42.8 g of the solvent D1), quality 4 (100 mg/l H202) and homogenized by stirring for 30 minutes. The color index of the 70% strength solution obtained was 17 Hazen immediately after mixing, and 14 Hazen after storage for 5 days at 50° C.

The comparison shows that diluting an exclusively non-ionically hydrophilized polyisocyanate with a peroxide-containing solvent does not lead to an increase in the color index over time, but rather has a brightening effect.

1. A polyisocyanate preparation comprising at least one polyisocyanate component A) hydrophilically modified with at least one ionic emulsifier and a solvent component E) consisting of at least one organic solvent, characterized in that the solvent component E) has a peroxide content of at most 70 mg/l H₂O₂ equivalents, wherein this value is the average peroxide content of all organic solvents present in the solvent component E), and the polyisocyanate component A) and the solvent component E) are present in amounts such that the calculated peroxide content of the polyisocyanate preparation is at most 20 mg/l H₂O₂, based on the sum of A) and E).

2. The polyisocyanate preparation as claimed in claim 1, characterized in that the hydrophilically modified polyisocyanate component A) consists of a polyisocyanate component B) and at least one ionic emulsifier C).

3. The polyisocyanate preparation as claimed in claim 1, characterized in that the polyisocyanate component B) is any diisocyanates, triisocyanates and/or polyisocyanates having aliphatically, cycloaliphatically, araliphatically and/or aromatically bonded isocyanate groups.

4. The polyisocyanate preparation as claimed in claim 1, characterized in that the polyisocyanate component B) was prepared by modifying PDI, HDI, IPDI, 4,4′-diisocyanatodicyclohexylmethane, XDI, 2,4- and/or 2,6-TDI.

5. The polyisocyanate preparation as claimed in claim 1, characterized in that the polyisocyanate component B) comprises isocyanurate group-containing polyisocyanates based on PDI, HDI and/or IPDI and/or urethane group-containing TDI polyisocyanates.

6. The polyisocyanate preparation as claimed in claim 1, characterized in that the ionic emulsifiers C) are reaction products of polyisocyanate components B) with organic compounds bearing at least one isocyanate-reactive group and at least one sulfonic acid or sulfonate group.

7. The polyisocyanate preparation as claimed in claim 1, characterized in that the ionic emulsifiers C) are reaction products of polyisocyanate components B) with amino-functional sulfonic acids of the general formula (III) and/or salts thereof, 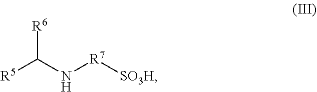
wherein in formula (III) R⁵ and R⁶ are each independently identical or different radicals and are hydrogen or saturated or unsaturated, linear or branched, aliphatic or cycloaliphatic or aromatic organic radicals having 1 to 18 carbon atoms, which are substituted or unsubstituted and/or comprise heteroatoms in the chain, wherein R⁵ and R⁶, in combination with each other and optionally one further nitrogen atom or one oxygen atom, may also form cycloaliphatic or heterocyclic rings having 3 to 8 carbon atoms, which may optionally be further substituted, and R⁷ is a linear or branched aliphatic radical having 2 to 6 carbon atoms.

8. The polyisocyanate preparation as claimed in claim 1, characterized in that the ionic emulsifiers C) are reaction products of polyisocyanate components B) with 2-isopropylaminoethane-1-sulfonic acid, 3-isopropylaminopropane-1-sulfonic acid, 4-isopropylaminobutane-1-sulfonic acid, 2-cyclohexylaminoethane-1-sulfonic acid, 3-cyclohexylaminopropane-1-sulfonic acid and/or 4-cyclohexylaminobutane-1-sulfonic acid and/or salts thereof.

9. The polyisocyanate preparation as claimed in claim 5, characterized in that the polyisocyanate component A) comprises at least 0.95% by weight, particularly preferably from 1.00 to 3.00% by weight, especially preferably from 1.10 to 1.80% by weight of sulfonate groups, calculated as SO₃; molar weight=80 g/mol, in chemically bonded form.

10. The polyisocyanate preparation as claimed in claim 1, characterized in that the solvent component E) consists of at least one organic solvent and has a peroxide content of at most 60 mg/l H₂O₂, wherein these values are the average peroxide content of all organic solvents present in the solvent component E).

11. The polyisocyanate preparation as claimed in claim 1, characterized in that the polyisocyanate component A) and the solvent component E) are present in amounts such that the calculated peroxide content of the polyisocyanate preparation, based on the sum of A) and E), is 1 to 20 mg/l H₂O₂.

12. The polyisocyanate preparation as claimed in claim 1, characterized in that the proportion of the solvent component E) is 5 to 90% by weight, of the total amount of the components A) and E).

13. (canceled)

14. A coating composition comprising at least one polyisocyanate preparation as claimed in claim 1.

15. A substrate coated with an optionally heat-cured coating composition as claimed in claim 14.
